(19) United States
(12) Patent Application Publication
(10) Pub. No.: US 2006/0152800 A1
(43) Pub. Date: Jul. 13, 2006

(54) Viewing device for industrial process transmitters

(75) Inventor: David A. Broden, Andover, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Rosemont, Inc., Eden Prairie, MN (US)

(21) Appl. No.: 11/031,769

(22) Filed: Jan. 7, 2005

(51) Int. Cl. G02B 23/00

(52) U.S. Cl. 359/431; 359/831

(57) ABSTRACT

The present invention is a viewing device for positioning in front of a local display of an industrial transmitter. The viewing device has optics that receive light from the local display along a first line of sight, redirect the light, and transmit the light along a second line of sight. The second line of sight is disposed at an angle relative to the first line of sight.

### BACKGROUND OF THE INVENTION

The present invention relates generally to field devices for use in monitoring industrial processes. In particular, the present invention relates to a viewing device that aids in viewing a display on an industrial process transmitter.

Transmitters for use with industrial processes typically include an electronics housing and a sensor module that attaches to the electronics housing. The sensor modules are designed to sense parameters associated with industrial processes such as, for example, pressure, temperature, density, concentration, flow characteristics, fluid level, pH, and viscosity. These industrial transmitters often include local displays, such as liquid crystal displays (LCDs), which are included in the electronics housing to allow monitoring personnel to view information related to the sensed parameter. Industrial transmitters are often mounted in crowded locations or in unexpected orientations and, as a result, viewing local displays can be difficult.

To ease problems associated with viewing local displays, some manufacturers have developed industrial transmitters that have a first axis of rotation that allows the electronics housing, including the local display, to rotate relative to the sensor module. In addition, the industrial transmitters typically also have a second axis of rotation that allows the local display to rotate relative to the electronics housing in the plane of the local display. Since these industrial transmitters do not have a third axis of rotation, located perpendicular to the first axis of rotation, about which the electronics housing can be rotated, the local displays may only be viewed from a restricted number of viewing orientations.

Some manufacturers have addressed the need to display in this “third axis” by offering industrial transmitters with different pre-determined housing configurations. Each of these housing configurations allows the local display to rotate through a different range of orientations relative to the sensor module. Prior to installation, an industrial transmitter is selected that has a range of display orientations suitable for a particular installation location. If the selected industrial transmitter is mismatched to the installation location, or if equipment surrounding the installation location is altered, the range of display orientations may be insufficient to allow for viewing of the local display.

As such, a need exists for a viewing device that will increase the number of viewing orientations from which the local displays of industrial transmitters may be viewed. The viewing device of the present invention meets this need.

### BRIEF SUMMARY OF THE INVENTION

The present invention comprises a viewing device for positioning in front of a local display of an industrial transmitter. The viewing device has optics that receive light from the local display along a first line of sight. The optics redirect the light and transmit the light along a second line of sight, which is disposed at an angle relative to the first line of sight.

### BRIEF DESCRIPTION OF THE DRAWINGS

FIG. 1A is a front view of an industrial transmitter with a vertically-oriented local display.

FIG. 1B is a side view of the industrial transmitter of FIG. 1A.

FIG. 2A is a side view of an industrial transmitter with a horizontally-oriented local display.

FIG. 2B is a top perspective view of the industrial transmitter of FIG. 2A.

FIG. 3 is a block-diagram representation of a viewing device of the present invention.

FIG. 4 shows a simplified diagram of a penta prism for use as optics in the viewing device of FIG. 3.

FIG. 5 shows a simplified diagram of a pair of mirrors for use as optics in the viewing device of FIG. 3.

FIG. 6 shows a partial cross-section of the industrial transmitter of FIG. 1A taken along line 1-1 of FIG. 1A, with an embodiment of the viewing device of FIG. 3 positioned in front of the local display.

FIG. 7 shows a simplified cross-sectional view of the industrial transmitter of FIG. 1A with the viewing device of FIG. 6 positioned in front of the local display.

FIG. 8 shows a simplified cross-sectional view of the industrial transmitter of FIG. 2A with the viewing device of FIG. 6 positioned in front of the local display.

While the above-identified drawing figures set forth several embodiments of the invention, other embodiments are also contemplated, as noted in the discussion.

In all cases, this disclosure presents the invention by way of representation and not limitation. It should be understood that numerous other modifications and embodiments can be devised by those skilled in the art that fall within the scope and spirit of the principles of the invention. The figures may not be drawn to scale. Like reference numbers have been used throughout the figures to denote like parts.

### DETAILED DESCRIPTION

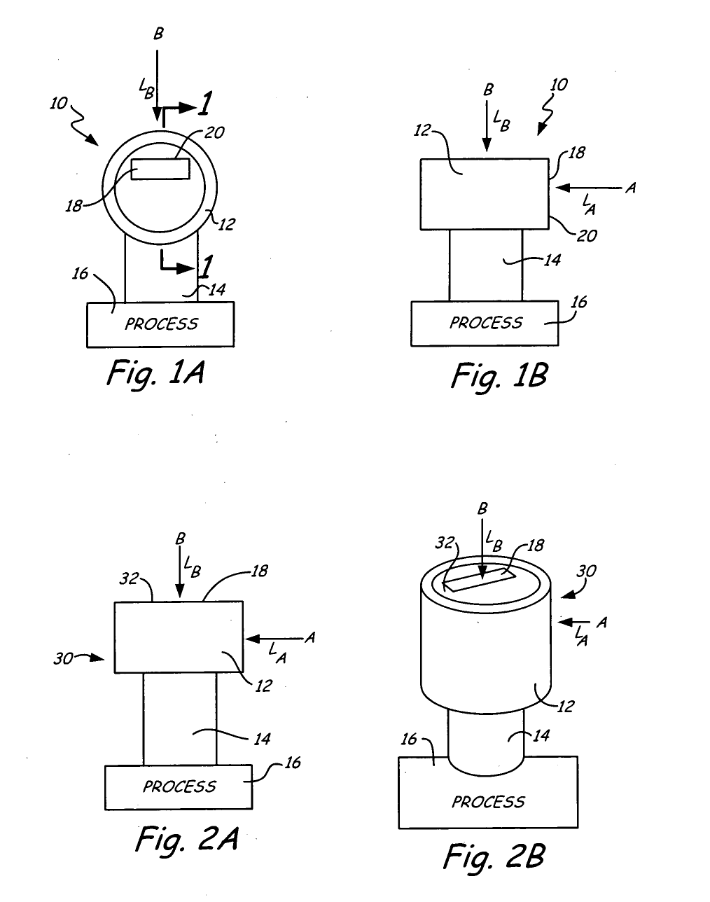

The viewing device of the present invention may be used to aid in viewing local displays included in any type and configuration of industrial transmitter known in the art. FIGS. 1A-2B illustrate two common industrial transmitter configurations.

FIGS. 1A and 1B show an industrial transmitter 10, with FIG. 1A showing a front view of industrial transmitter 10 and FIG. 1B showing a side view of industrial transmitter 10. Industrial transmitter 10 includes an electronics housing 12 attached to a sensor module 14. Sensor module 14 is in communication with an industrial process 16 and contains at least one sensor (not shown) for sensing a parameter associated with industrial process 16. Examples of sensed parameters include pressure, temperature, pH, flow characteristics (e.g., flow rate), viscosity, density, concentration, and fluid level. Electronics housing 12 houses electronics (not shown) that are in communication with the sensor(s) in sensor module 14. The electronics within electronics housing 12 process transmitter information for viewing on local display 18.

As shown in FIG. 1A, local display 18 may be a liquid crystal display (LCD). In addition, local display 18, may also be any other type of display known in the art, including, for example, an analog-type needle display. Local display 18 is located on a vertical face 20 of electronics housing 12. In this configuration, local display 18 is viewable from a viewing orientation A along a first line of sight, L_{A}, which is located generally horizontal and parallel to process 16. Local display 18 is not viewable from a viewing orientation B along a second line of sight, L_{B}, which looks downward towards process 16 and is oriented generally perpendicular with respect to L_{A}.

FIGS. 2A and 2B show an industrial transmitter 30, with FIG. 2A, showing a side view of industrial transmitter 30 and FIG. 2B showing a top perspective view of industrial transmitter 30. Industrial transmitter 30 is similar to industrial transmitter 10, except electronics housing 12 is configured so that local display 18 is located on a horizontal face 32 of electronics housing 12 opposite process 16. In this configuration, local display 18 is viewable from viewing orientation B along L_{B}, but is not viewable from viewing orientation A along L_{A}.

Thus, neither industrial transmitter 10 or industrial transmitter 30 has a local display 18 that is viewable from both viewing orientation A along L_{A} and viewing orientation B along L_{B}. Therefore, in many industrial transmitter applications, the desired viewing orientation for the transmitter may need to be determined prior to installation to ensure that a transmitter with an appropriate local display configuration is installed. For example, if a given installation location dictates that local display 18 should be viewable from viewing orientation A, industrial transmitter 10 should be installed, whereas if a given installation location dictates that local display 18 should be viewable from viewing orientation B, industrial transmitter 30 should be installed.

The viewing device of the present invention provides additional viewing flexibility for viewing local display 18. This additional viewing flexibility can avoid the need for installing an industrial transmitter with a configuration tailored to a specific installation location.

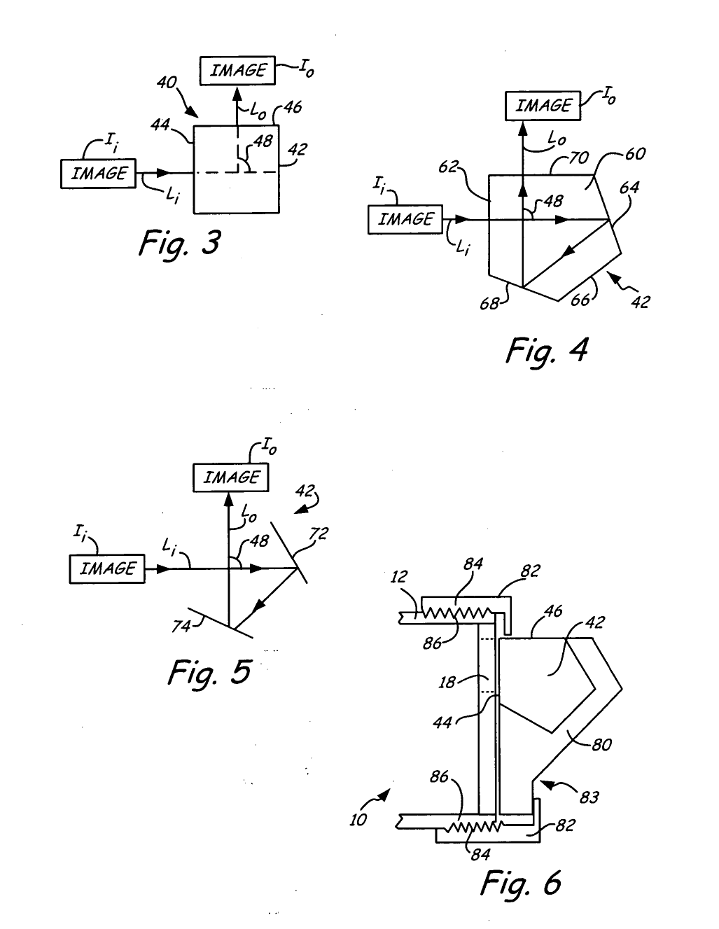

FIG. 3 shows a block diagram representation of a viewing device 40 of the present invention. Viewing device 40 includes optics 42, which has an input 44 and an output 46. As shown in FIG. 3, when light from an input image, Iᵢ, enters input 44 of optics 42 along an input line of sight, Lᵢ, the light is redirected to output 46 along an output line of sight, Lₒ, to form an output image, Iₒ. In some embodiments, Iₒ is neither inverted nor reversed with respect to Iᵢ.

Optics 42 redirects the light from input 44 to output 46 through an angle 48, which represents the amount of rotation that a ray of light entering input 44 along L must undergo relative to Lᵢ to exit output 46 along L_{O}. In some embodiments, angle 48 is at least about forty-five degrees. In the embodiment shown in FIG. 3, angle 48 is about ninety degrees.

FIG. 4 shows a simplified diagram of an embodiment of optics 42 for use in viewing device 40 of FIG. 3. As shown in FIG. 4, optics 42 includes a penta prism 60 formed from a solid material (i.e., non-hollow). Penta prism 60 has an input face 62, a reflective face 64, a non-reflecting face 66, a reflecting face 68, and an output face 70. In some embodiments, reflecting faces 64 and 68 may be coated with any suitable reflective coating known in the art. In the embodiment shown in FIG. 4, input face 62 and output face 70 are located at an angle of about ninety degrees relative to each other. When light from Iᵢ enters input 62 along Lᵢ, the light is reflected off reflective faces 64 and 68 and is directed through output face 70 to generate Iₒ along Lₒ. As shown in FIG. 4, Iₒ has an orientation that is neither inverted nor reversed with respect to Iᵢ.

FIG. 5 shows a simplified diagram of another embodiment of optics 42 for use in viewing device 40 of FIG. 3. As shown in FIG. 5, optics 42 includes a pair of mirrors 72 and 74, which may comprise any type of reflective surface known in the art. Mirrors 72 and 74 are angled with respect to Lᵢ so that light from Iᵢ that enters optics 42 along Lᵢ is reflected first off mirror 72 and then off mirror 74. The light exits optics 42 along Lₒ to generate Iₒ, which has an orientation that is neither inverted nor reversed with respect to Iᵢ.

In other embodiments of the present invention, optics 42 may include any reflection or refraction means known in the art in any combination. Optical bodies having any number of faces, or sides, may be included in optics 42 provided that the faces of the optical bodies are configured so that optics 42 redirects light from local display 18 so that local display 18 can be viewed from a different direction. These optical bodies may be either hollow or solid. In applications where a reversal of the left-right orientation of Iₒ is not important (e.g., when local display 18 displays information in certain types of vertical formats), optics 42 may include a single mirror for redirecting light from input 44 to output 46 of optics 42.

FIG. 6 shows a partial cross-section of electronics housing 12 of industrial transmitter 10 taken along line 1-1 of FIG. 1A. An embodiment of viewing device 40 of FIG. 3 is shown positioned in front of local display 18 of industrial transmitter 10 of FIG. 1A. In this particular embodiment, viewing device 40 includes an optics retainer 80 and a coupling 82 to connect viewing device 40 to industrial transmitter 10 and position optics 42 in front of local display 18 so that light from local display 18 can enter input 44 of optics 42. In some embodiments, optics retainer 80 can be formed from a plurality of members, as opposed to a single member as shown in FIG. 6.

In the embodiment shown in FIG. 6, coupling 82 is a collar with a hole 83 to receive optics 42. Coupling 82 includes threads 84 so that coupling 82 can be threaded onto a threaded portion 86 of electronics housing 12. In other embodiments, coupling 82 may include screws, bolts, clamps, pins, locks, latches, or any other attachment means or combination of attachment means known in the art. In some embodiments, coupling 82 and optics 42 comprise a single contiguous body formed from a material such as, for example, plastic. In addition, any other means known in the art may be used to connect viewing device 40 to the industrial transmitter.

In still other embodiments, viewing device 40 is positioned in front of local display 18 without mounting or connecting viewing device 40 to electronics housing 12. This can be accomplished, for example, by attaching viewing device 40 to other parts of industrial transmitter 10 or surrounding process equipment.

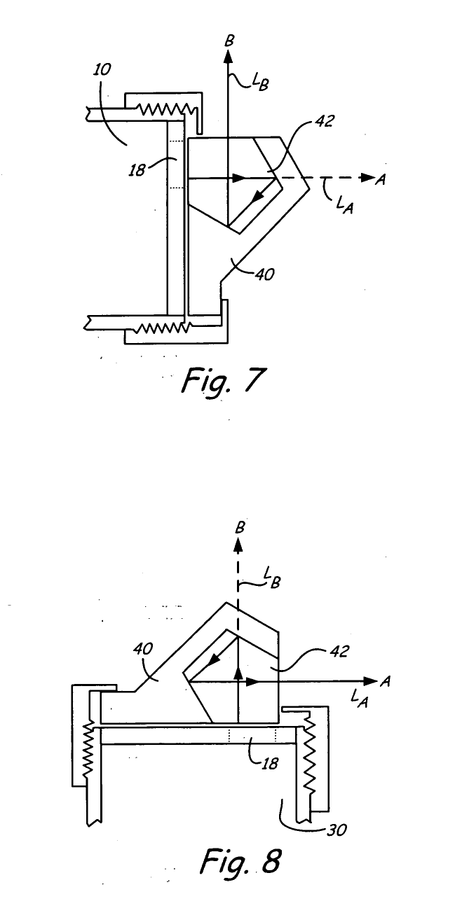

FIGS. 7 and 8 illustrate the ability of viewing device 40 to be used to modify the viewing angle of industrial transmitter displays. FIG. 7 shows viewing device 40 mounted on industrial transmitter 10 of FIG. 1A, while FIG. 8 shows viewing device 40 mounted on industrial transmitter 30 of FIG. 2A. As shown in FIG. 7, industrial transmitter 10, which has a vertically-oriented local display 18 viewable along L_{A} at viewing orientation A, may be modified using viewing device 40 so that local display 18 can be viewed from viewing orientation B along L_{B}. Likewise, as shown in FIG. 8, industrial transmitter 30, which has a horizontally-oriented local display 18 viewable along L_{B} at viewing orientation B, can be modified using viewing device 40 so that local display 18 can be viewed from viewing orientation A along L_{A}.

Thus, as illustrated above, when industrial transmitters 10 and 30 are equipped with viewing device 40, local display 18 may be viewed from both viewing orientation A and viewing orientation B. This can be accomplished by positioning viewing device 40 in front of local display 18 or removing viewing device 40 from local display 18, depending upon which viewing orientation is desired. As such, viewing device 40 can avoid the need for purchasing industrial transmitters having different local display configurations.

In some embodiments, viewing device 40 can be included as a component of the industrial transmitter. In other embodiments, viewing device 40 can be provided to retrofit existing industrial transmitters already in use in the field. In addition, in some embodiments viewing device 40 can be used to facilitate the viewing of local displays belonging to industrial transmitters or other field devices which do not include a sensor or a sensor module.

As described above, the viewing device of the present invention, when positioned in front of a local display of an industrial transmitter facing in a first direction, permits the local display to be viewed from a second, different direction. The viewing device has optics that include an input and an output. The optics receive light from the local display at the input and redirect the light to the output so that an image displayed on the local display is viewable from the second direction.

Although the present invention has been described with reference to preferred embodiments, workers skilled in the art will recognize that changes may be made in form and detail without departing from the spirit and scope of the invention.

1. A viewing device for an industrial process transmitter having an industrial process transmitter display, the industrial process transmitter capable of producing an electrical signal as a function of a sensed parameter associated with an industrial process and displaying process information on the industrial process transmitter display as a function of the electrical signal, the viewing device comprising:
optics positionable in front of the industrial process transmitter display to receive light from the display along a first line of sight and redirect the light along a second line of sight disposed at an angle relative to the first line of sight to permit viewing of the process information when displayed on the display as a function of the electrical signal; and
means for attaching the optics to the industrial process transmitter so that the optics are positioned in front of the display.

2. The viewing device of claim 1, wherein the optics comprise a penta prism.

3. The viewing device of claim 1, wherein the optics comprise a mirror.

4. The viewing device of claim 1, wherein the optics comprise a pair of mirrors.

5. The viewing device of claim 1, wherein the optics produce an output image along the second line of sight that is not reversed relative to an input image on the display.

6. The viewing device of claim 1, wherein the optics produce an output image along the second line of sight that is not inverted relative to an input image on the display.

7. The viewing device of claim 1, wherein the first line of sight and the second line of sight are disposed at an angle of at least about forty-five degrees to each other.

8. The viewing device of claim 7, wherein the first line of sight and the second line of sight are disposed at about a ninety-degree angle to each other.

9. A viewing device for use with an industrial process transmitter having an industrial transmitter display facing in a first direction, the industrial process transmitter including a sensor for sensing a parameter associated with an industrial process and generating an electrical signal as a function of the sensed parameter, the viewing device comprising:
a housing having an inlet and an outlet;
an attachment adapted to attach the housing to the industrial process transmitter and position the inlet of the housing in front of the industrial process transmitter display;
optics within the housing for redirecting light from the industrial process transmitter display to the outlet to permit process information displayed on the industrial process transmitter display as a function of the electrical signal to be viewed from a second direction at an angle relative to the first direction.

10. The viewing device of claim 9, wherein the angle comprises at least about a forty-five degree angle.

11. The viewing device of claim 9, wherein the angle comprises about a ninety degree angle.

12. The viewing device of claim 9, wherein the optics comprise a penta prism.

13. The viewing device of claim 9, wherein the optics comprise a mirror.

14. The viewing device of claim 9, wherein the optics comprise a pair of mirrors.

15. The viewing device of claim 9, wherein the optics produce an output image, viewable from the second direction, that is not reversed relative to an input image on the display.

16. The viewing device of claim 9, wherein the optics produce an output image, viewable from the second direction, that is not inverted relative to an input image on the display.

17. A method of modifying an industrial process transmitter having an industrial process transmitter display, the industrial process transmitter capable of producing an electrical signal as a function of a sensed parameter associated with an industrial process, the method comprising:
displaying process information on the industrial process transmitter display as a function of the electrical signal;
positioning an optical element with respect to the industrial process transmitter so that light from the industrial process transmitter display, positioned for viewing along a first line of sight, may enter the optical element; and
redirecting light through the optical element so that the display is viewable along a second, different line of sight to permit viewing of the process information when displayed on the industrial process transmitter display.

18. The method of claim 17, wherein the optical element redirects the light so that the display is viewable from a viewing orientation that the display was not viewable from before positioning the optical element with respect to the display.

19. The method of claim 17, wherein the optical element comprises a penta prism.

20. The method of claim 17, wherein the optical element comprises a mirror.

21. The method of claim 17, wherein the optical element comprises a pair of mirrors.

22. The method of claim 17 further comprising:
producing an output image from the redirected light that is viewable along the second line of sight and is not inverted with respect to an input image on the display.

23. The method of claim 17 further comprising:
producing an output image from the redirected light that is viewable along the second line of sight and is not reversed with respect to an input image on the display.

24. A system for viewing information related to an industrial process, the system comprising:
an industrial process transmitter having an industrial process transmitter display for displaying process information as a function of an electrical signal generated as a function of a sensed parameter associated with the industrial process; and
a viewing device comprising:
optics positioned in front of the industrial process transmitter display to receive light from the display along a first line of sight and redirect the light along a second line of sight disposed at an angle relative to the first line of sight to permit viewing of the process information along the second line of sight; and
means for attaching the optics to the industrial process transmitter so that the optics are positioned in front of the display.
